(19) United States
(12) Patent Application Publication
(10) Pub. No.: US 2026/0242230 A1
(43) Pub. Date: Aug. 20, 2026

(54) ION PERMEABLE MEMBRANE

(71) Applicant: IDEMITSU KOSAN CO.,LTD., Tokyo (JP)

(72) Inventors: Toshiaki TSUNO, Chiyoda-ku, Tokyo (JP); Futoshi UTSUNO, Chiyoda-ku, Tokyo (JP)

(73) Assignee: IDEMITSU KOSAN CO.,LTD., Tokyo (JP)

(21) Appl. No.: 19/161,824

(22) PCT Filed: Mar. 22, 2024
(86) PCT No.: PCT/JP2024/011386

§ 371 Date: Sep. 3, 2025

(30) Foreign Application Priority Data
Mar. 29, 2023 (JP) 2023-053556

(51) Int. Cl. C01D 15/02; B01J 39/19; C01D 15/06; H01M 4/485; H01M 10/0525; H01M 10/0562

(52) U.S. Cl. CPC C01D 15/02; B01J 39/19; C01D 15/06; H01M 4/485; H01M 10/0525; H01M 10/0562; H01M 2300/0068

(57) ABSTRACT

The object of the present invention is to provide an ion permeable membrane which has high quality as a permeable membrane, is capable of coping with an increase in size, has improved yields, has improved handleability, and is achieving weight reduction, and includes a solid electrolyte exhibiting alkalinity and a resin containing a carboxy group, and has an acid value of more than 0 mgKOH/g.

### TECHNICAL FIELD

The present invention relates to an ion permeable membrane.

### BACKGROUND ART

In recent years, lithium secondary batteries and the like have been used in fields such as information-related devices and communication devices, such as personal computers, video cameras, and mobile phones, and their use in hybrid cars and electric cars, which have been developed in response to carbon dioxide emission regulations, has also been considered. Therefore, there is an urgent need to secure lithium sources more than ever before, and as part of this, technologies for recovering lithium by recycling lithium secondary batteries have been developed (for example, see PTL 1).

As an ion permeable membrane used for recovering ions such as lithium, in addition to the lithium selective permeable membrane described in PTL 1, for example, PTL 2 proposes a membrane for separating target ions, which contains a material including a target ion permeable ceramic and a target ion permeable organic polymer that is bonded to the permeable ceramic.

### CITATION LIST

### Patent Literature

PTL 1: JP 2019-81953 A
PTL 2: JP 2022-543897 T

### SUMMARY OF INVENTION

### Technical Problem

The present invention has been made in consideration of the above-mentioned circumstances, and has an object to provide an ion permeable membrane that has high quality as a permeable membrane, is capable of coping with an increase in size, has improved yields, has improved handleability, and is lightweight.

### Solution to Problem

An ion permeable membrane according to the present invention is an ion permeable membrane including a solid electrolyte exhibiting alkalinity and a resin containing a carboxy group, in which the ion permeable membrane has an acid value of more than 0 mgKOH/g.

### Advantageous Effects of Invention

According to the present invention, it is possible to provide an ion permeable membrane that has high quality as a permeable membrane, is capable of coping with an increase in size, has improved yields, has improved handleability, and is achieving weight reduction.

### BRIEF DESCRIPTION OF DRAWINGS

FIG. 1 is a schematic diagram showing an example of a preferred configuration of an ion recovery device using an ion permeable membrane of the present embodiment.

FIG. 2 is a schematic diagram showing an electrodeposition apparatus used in a Li selectivity test in the Examples.

FIG. 3 is a scanning electron microscope (SEM) image of a cross section of the ion permeable membrane produced in Example 4 (magnification: 1000 times).

FIG. 4 is an SEM image of a cross section of the ion permeable membrane produced in Comparative Example 2 (magnification: 1000 times).

### DESCRIPTION OF EMBODIMENTS

Hereinafter, an embodiment of the present invention (hereinafter, sometimes referred to as “the present embodiment”) will be described. In addition, in the description herein, the numerical values of the upper limit and the lower limit relating to the numerical range of “or more”, “or less”, and “to” are numerical values that can be arbitrarily combined, and the numerical values of the examples can also be used as the numerical values of the upper limit and the lower limit.

### Findings Obtained by the Present Inventors to Reach the Present Invention

Incidentally, with an increase in demand for lithium in recent years, an increase in size of an apparatus and an improvement in efficiency of lithium recovery have been required more than ever. The technique described in PTL 1 is a technique in which lithium ions are recovered from a stock solution containing lithium ions using a lithium ion conductor, and the lithium selective permeable membrane used therein is an extremely useful technique. However, the lithium selective permeable membrane using the lithium ion conductor has room for improvement in handleability because of coping with an increase in size, easy occurrence of cracking and strain at the time of production, improvement in yield, and easy cracking at the time of transportation and the like. In addition, since it is heavy, weight reduction is also required to cope with an increase in size.

On the other hand, since the membrane for separating target ions described in PTL 2 contains a target ion permeable organic polymer that binds to a permeable ceramic, the membrane can easily cope with an increase in size as compared with the permeable membrane described in PTL 1, and the occurrence of cracking and distortion at the time of production and the occurrence of cracking at the time of transportation are suppressed. However, the function as a permeable membrane is likely to deteriorate due to the occurrence of pinholes, and there is a significant problem in improving the quality as a permeable membrane.

Thus, permeable membranes that allow specific atoms (ions) to pass through need to have high quality as permeable membranes, but there is also room for improvement in terms of coping with an increase in size, yields, handleability, and weight reduction.

In view of the problems in the permeable membranes described in PTLs 1 and 2, the present inventors have focused on resins used for the permeable membranes, and have conducted studies for improvement. In the course of the studies, it has been found that when a resin containing a carboxy group is used, the binding property to a substance having ion permeability such as a lithium ion conductor is excellent. It is considered that since the binding property between the substance having ion permeability and the resin is excellent, the occurrence of pinholes due to the interface therebetween is suppressed, so that a high-quality permeable membrane can be obtained. In addition, it is considered that it is possible to cope with an increase in size, and to improve yields, handleability, and weight reduction.

In this way, the present inventors have obtained a permeable membrane capable of solving the above-described problems by combining a substance having ion permeability with a resin containing a carboxy group.

### Regarding Various Aspects of the Present Embodiment

An ion permeable membrane according to a first aspect of the present embodiment is an ion permeable membrane that includes a solid electrolyte exhibiting alkalinity and a resin containing a carboxy group, and has an acid value of more than 0 mgKOH/g.

The ion permeable membrane according to the present embodiment selectively permeates ions to be recovered, substantially permeates only ions such as metal ions to be recovered in the treatment liquid containing metal ions such as lithium ions, and does not permeate other ions and water.

In the description herein, the “solid electrolyte” means an electrolyte that maintains a solid state at 25° C. under a nitrogen atmosphere. Moreover, “exhibiting alkalinity” means that the pH of a solution in which the solid electrolyte is dispersed is 7.0 or higher.

The ion permeable membrane according to the present embodiment includes a resin having a carboxy group as a group exhibiting acidity, whereby the acid value is more than 0 mgKOH/g. It is considered that by combining such a resin having a group exhibiting acidity with a solid electrolyte exhibiting alkalinity, an excellent binding property is obtained as described above, and thus occurrence of pinholes is suppressed. In addition, it becomes possible to cope with an increase in size, and furthermore, cracking and distortion at the time of production are less likely to occur, yield and handleability are good, and weight reduction can be achieved.

An ion permeable membrane according to a second aspect of the present embodiment is such that, in the first aspect, the solid electrolyte exhibiting alkalinity is an oxide solid electrolyte.

The oxide solid electrolyte used in the present embodiment exhibits alkalinity and can improve the recovery efficiency of lithium ions.

An ion permeable membrane according to a third aspect of the present embodiment is such that, in the first or second aspect, the resin containing a carboxy group is a resin selected from a block copolymer containing a monomer having a carboxy group and an acid-modified resin graft-modified with a compound having a carboxy group.

The resin containing a carboxy group is preferably a resin selected from a block copolymer containing a monomer having a carboxy group and an acid-modified resin graft-modified with a compound having a carboxy group from the viewpoint of making the binding property with the solid electrolyte exhibiting alkalinity more excellent.

An ion permeable membrane according to a fourth aspect of the present embodiment is such that, in the third aspect, the block copolymer is a block copolymer of a monomer having a carboxy group and an olefin monomer.

The block copolymer is preferably a block copolymer of a monomer having a carboxy group and an olefin monomer from the viewpoint of making the binding property with the solid electrolyte exhibiting alkalinity more excellent.

An ion permeable membrane according to a fifth aspect of the present embodiment is such that, in the third aspect, the main chain of the acid-modified resin is formed by an olefin monomer.

The main chain of the acid-modified resin is preferably formed of an olefin monomer from the viewpoint of making the binding property with the solid electrolyte exhibiting alkalinity more excellent.

An ion permeable membrane according to a sixth aspect of the present embodiment is such that, in the third or fourth aspect, the monomer having a carboxy group is a compound selected from an unsaturated carboxylic acid and a derivative thereof.

In a case where the monomer having a carboxy group is a compound selected from an unsaturated carboxylic acid and a derivative thereof, the binding property with the solid electrolyte exhibiting alkalinity becomes more excellent.

An ion permeable membrane according to a seventh aspect of the present embodiment is such that, in the third or fifth aspect, the compound having a carboxy group is a compound selected from an unsaturated carboxylic acid and a derivative thereof.

When the compound having a carboxy group is a compound selected from an unsaturated carboxylic acid and a derivative thereof, the binding property with the solid electrolyte exhibiting alkalinity becomes more excellent.

An ion permeable membrane according to an eighth aspect of the present embodiment is such that, in the sixth or seventh aspect, the monomer having a carboxy group and the compound having a carboxy group are each a compound selected from acrylic acid, methacrylic acid, maleic acid, and derivatives thereof.

When the monomer having a carboxy group and the compound having a carboxy group are compounds selected from acrylic acid, methacrylic acid, maleic acid, and derivatives thereof, the binding property with the solid electrolyte exhibiting alkalinity becomes more excellent.

An ion permeable membrane according to a ninth aspect of the present embodiment is such that, in any one of the first to seventh aspects, the ion permeable membrane further includes a resin not containing a carboxy group.

The ion permeable membrane of the present embodiment further includes a resin not containing a carboxy group, whereby the resin and the solid electrolyte are more uniformly present, so that the adhesion is enhanced, and as a result, water can be made less likely to permeate.

An ion permeable membrane according to a tenth aspect of the present embodiment is such that, in the ninth aspect, the resin not containing a carboxy group is an olefin resin. The resin not containing a carboxy group is preferably an olefin resin from the viewpoint of the binding property with the resin containing a carboxy group and making it more difficult for water to permeate.

An ion permeable membrane according to an eleventh aspect of the present embodiment is such that, in any one of the first to tenth aspects, a content of the resin containing a carboxy group is 1% by mass or more and 30% by mass or less.

In the ion permeable membrane of the present embodiment, the content of the resin containing a carboxy group is preferably within the above range from the viewpoint of making the binding property with the solid electrolyte exhibiting alkalinity more excellent.

An ion permeable membrane according to a twelfth aspect of the present embodiment is such that, in any one of the first to eleventh aspects, the acid value is more than 0 mgKOH/g and 20 mgKOH/g or less.

From the viewpoint of further exhibiting the effects of the present disclosure, the ion permeable membrane of the present embodiment preferably has an acid value within the above range.

An ion permeable membrane according to a thirteenth aspect of the present embodiment is the ion permeable membrane according to any one of the first to twelfth aspects, which allows lithium ions to permeate, and an ion permeable membrane according to a fourteenth aspect of the present embodiment is the ion permeable membrane according to any one of the first to thirteenth aspects, which is for recovering lithium ions.

The ion permeable membrane of the present embodiment can be suitably used for recovery of lithium ions.

A lithium recovery device according to a fifteenth aspect of the present embodiment is a lithium recovery device including an ion permeable membrane that includes a solid electrolyte exhibiting alkalinity and a resin containing a carboxy group and has an acid value of more than 0 mgKOH/g.

The ion permeable membrane employed in the lithium recovery device of the present embodiment has high quality as a permeable membrane, while being coping with an increase in size, improving yields, improving handleability, and achieving weight reduction. Therefore, the lithium recovery device of the present embodiment including this can efficiently recover lithium, and can easily cope with an increase in size.

A method for producing lithium hydroxide according to a sixteenth aspect of the present embodiment is a method for producing lithium hydroxide, including recovering lithium hydroxide from a lithium ion-containing liquid using an ion permeable membrane that includes a solid electrolyte exhibiting alkalinity and a resin containing a carboxy group and has an acid value of more than 0 mgKOH/g.

The ion permeable membrane employed in the lithium recovery device of the present embodiment has high quality as a permeable membrane, while being coping with an increase in size, improving yields, improving handleability, and achieving weight reduction. Therefore, the method for producing lithium hydroxide of the present embodiment using this can efficiently produce lithium hydroxide.

A method for producing a lithium-containing substance according to a seventeenth aspect of the present embodiment is a method for producing a lithium-containing substance, including: recovering lithium hydroxide from a lithium ion-containing liquid by using an ion permeable membrane that includes a solid electrolyte exhibiting alkalinity and a resin containing a carboxy group and has an acid value of more than 0 mgKOH/g; and using the lithium hydroxide to produce a lithium-containing substance selected from lithium sulfide, a sulfide solid electrolyte, and an electrode active substance.

The method for producing a lithium-containing substance of the present embodiment is a method for producing a lithium-containing substance selected from lithium sulfide, a sulfide solid electrolyte, and an electrode active substance by using the lithium hydroxide obtained by the method for producing lithium hydroxide of the present embodiment. According to the method for producing lithium hydroxide of the present embodiment, as described above, lithium hydroxide can be efficiently produced. As a result, according to the method for producing a lithium-containing substance of the present embodiment, the lithium-containing substance can be efficiently produced.

A method for producing a lithium ion battery according to an eighteenth aspect of the present embodiment is a method for producing a lithium ion battery, including: recovering lithium hydroxide from a lithium ion-containing liquid by using an ion permeable membrane that includes a solid electrolyte exhibiting alkalinity and a resin containing a carboxy group and has an acid value of more than 0 mgKOH/g; obtaining a lithium-containing substance selected from lithium sulfide, a sulfide solid electrolyte, and an electrode active substance by using the lithium hydroxide; and using a substance selected from the lithium-containing substances.

The method for producing a lithium ion battery of the present embodiment is a method for producing a lithium ion battery by mixing a lithium-containing substance selected from the lithium-containing substances obtained by the method for producing a lithium-containing substance of the present embodiment. According to the method for producing a lithium-containing substance of the present embodiment, as described above, the lithium-containing substance can be efficiently produced. As a result, according to the method for producing a lithium ion battery of the present embodiment, a lithium ion battery can be efficiently produced.

### (Ion Permeable Membrane)

The ion permeable membrane of the present embodiment is an ion permeable membrane that includes a solid electrolyte exhibiting alkalinity and a resin containing a carboxy group, and has an acid value of more than 0 mgKOH/g.

As described above, since the ion permeable membrane of the present embodiment has an acid value of more than 0 mgKOH/g by including the resin containing a carboxy group, the ion permeable membrane of the present embodiment becomes a permeable membrane of excellent quality in which the binding property with the solid electrolyte exhibiting alkalinity is improved and the occurrence of pinholes is suppressed. The acid value of the ion permeable membrane is preferably more than 0 mgKOH/g and 20 mgKOH/g or less, more preferably 1 mgKOH/g or more and 18 mgKOH/g or less, and still more preferably 2 mgKOH/g or more and 15 mgKOH/g or less.

In the description herein, the acid value can be measured in accordance with JIS K0070:1992, and specifically, can be measured by the method described in Examples.

The acid value of the ion permeable membrane can be appropriately adjusted by the type and content of the resin containing a carboxy group.

The ion permeable membrane of the present embodiment may be a single layer or a multilayer in which two or more layers are laminated.

From the viewpoint of expression of ion selectivity, the film thickness of the ion permeable membrane is preferably 0.1 μm or more, more preferably 1 μm or more, still more preferably 10 μm or more, and yet still more preferably 50 μm or more. On the other hand, from the viewpoint of further suppressing the occurrence of cracking and the like and improving the ion recovery rate, the film thickness is preferably 1 mm or less, more preferably 500 μm or less, still more preferably 300 μm or less, and yet still more preferably 200 μm or less.

In addition, in a case where the ion permeable membrane has a multilayer, the film thickness of the ion permeable membrane is the total thickness of each layer.

The ion to be selectively permeated by the ion permeable membrane of the present embodiment is preferably a metal ion which is a cation in which a metal atom has lost an electron, preferably a metal ion of a typical metal or a transition metal, more preferably a metal ion of an alkali metal, a metal ion of an alkaline earth metal, a metal ion of a magnesium group, a metal ion of an aluminum group, a metal ion of a rare earth group, a metal ion of an iron group, a metal ion of a chromium group, a metal ion of a manganese group, a metal ion of a noble metal, a metal ion of a platinum group, a metal ion of a lanthanoid metal, or a metal ion of an actinoid metal, still more preferably a metal ion of an alkali metal, a metal ion of an alkaline earth metal, a metal ion of a noble metal, a metal ion of a platinum group, a metal ion of a lanthanoid metal, or a metal ion of an actinoid metal, yet still more preferably a metal ion of an alkali metal, yet still more preferably a lithium ion or a sodium ion, and particularly preferably a lithium ion.

Therefore, the ion permeable membrane of the present embodiment is preferably used for recovering metal ions. As the metal ion, the above-described metal ions are preferably exemplified, and among them, the metal ion is preferably used for recovering lithium ions or sodium ions, and particularly preferably used for recovering lithium ions.

### (Solid Electrolyte Exhibiting Alkalinity)

The solid electrolyte used in the present embodiment is not particularly limited as long as it exhibits alkalinity, and is preferably an oxide solid electrolyte from the viewpoint of further increasing the recovery efficiency of ions.

Examples of the oxide solid electrolyte include a NASICON (Natrium super ionic conductor) type oxide (for example, Li_{3.5}Zn_{0.25}GeO₄), a LISICON (Lithium super ionic conductor) type oxide (for example, Li_{3.5}Zn_{0.25}GeO₄), a garnet type oxide (for example, Li₇La₃Zr₂O₁₂, LLZO), and a perovskite type oxide (for example, La_{0.55}Li_{0.35}TiO₃).

More specifically, lithium lanthanum titanate: (Liₓ, La_{y})TiO_{z} (here, x=3a−2b, y=⅔−a, z=3−b, 0<a≤⅙, 0≤b≤0.06, x>0) (hereinafter, LLTO) can be used, and further more specifically, Li_{0.29}La_{0.57}TiO₃ (a≈0.1, b≈0) can be used. These materials can be obtained, for example, as a sintered body obtained by mixing particles formed of these materials with a sintering aid or the like and sintering the mixture at a high temperature (1000° C. or higher).

The shape of the solid electrolyte exhibiting alkalinity is not particularly limited, and examples thereof include a particle shape. The median diameter of the particles of the solid electrolyte exhibiting alkalinity is preferably 100 μm or less, and more preferably 10 μm or less, from the viewpoint of further reducing the resistance of the ion permeable membrane. On the other hand, from the viewpoint of suppressing an increase in the interfacial resistance between the particles and the interfacial resistance between the particles and the carboxy group-containing resin, the median diameter of the particles of the solid electrolyte exhibiting alkalinity is preferably 1 nm or more, and more preferably 10 nm or more.

In the description herein, the median diameter of the particles of the solid electrolyte exhibiting alkalinity is a volume-based median diameter measured using a laser diffraction/scattering type particle size distribution measuring device.

The content of the solid electrolyte exhibiting alkalinity contained in the ion permeable membrane is preferably 70% by mass or more and 99% by mass or less, more preferably 75% by mass or more and 99% by mass or less, and still more preferably 80% by mass or more and 99% by mass or less. When the content of the solid electrolyte exhibiting alkalinity is 70% by mass or more, the recovery efficiency of ions can be further enhanced, and when the content of the solid electrolyte exhibiting alkalinity is 99% by mass or less, cracking and distortion at the time of production are less likely to occur, and the yield and the handleability become better.

### (Resin Containing Carboxy Group)

The resin containing a carboxy group used in the present embodiment is not particularly limited as long as it has one or more carboxy groups in one molecule, and is preferably a resin selected from a block copolymer containing a monomer having a carboxy group and an acid-modified resin graft-modified with a compound having a carboxy group, from the viewpoint of making the binding property with the solid electrolyte exhibiting alkalinity more excellent.

The resin containing a carboxy group may be used alone or in combination of two or more kinds thereof.

### (Block Copolymer Containing Monomer Having Carboxy Group)

The block copolymer containing a monomer having a carboxy group (hereinafter, also simply referred to as “block copolymer”) is preferably a block copolymer of a monomer having a carboxy group and an olefin monomer. When the block copolymer is used together with a resin not containing a carboxy group described later, the affinity between the resin containing a carboxy group and the resin not containing a carboxy group is enhanced, and therefore, an ion permeable membrane having higher quality can be obtained.

The monomer having a carboxy group is preferably a compound selected from an unsaturated carboxylic acid and derivatives thereof from the viewpoint of making the binding property with the solid electrolyte exhibiting alkalinity more excellent.

Examples of the unsaturated carboxylic acid include acrylic acid, methacrylic acid, maleic acid, fumaric acid, itaconic acid, crotonic acid, citraconic acid, sorbic acid, mesaconic acid, and angelic acid. Examples of the derivatives thereof include acid anhydrides, esters, amides, imides, and metal salts, and examples thereof include maleic anhydride, itaconic anhydride, citraconic anhydride, methyl acrylate, methyl methacrylate, ethyl acrylate, butyl acrylate, 2-ethylhexyl acrylate, maleic acid monoethyl ester, acrylamide, maleic acid monoamide, maleimide, N-butylmaleimide, sodium acrylate, and sodium methacrylate.

The monomer having a carboxy group is preferably a compound selected from acrylic acid, methacrylic acid, maleic acid, and derivatives thereof, and more preferably acrylic acid or maleic anhydride, from the viewpoint of making the binding property with the solid electrolyte exhibiting alkalinity more excellent. These may be used alone or in combination of two or more kinds thereof.

The content of the monomer having a carboxy group contained in the block copolymer is preferably 0.1 to 50% by mass, more preferably 1 to 20% by mass, and still more preferably 1.5 to 15% by mass, from the viewpoint of making the binding property with the solid electrolyte exhibiting alkalinity more excellent.

As the olefin monomer, for example, one or more selected from α-olefins having 2 to 30 carbon atoms can be used. Specific examples thereof include linear olefins such as ethylene, propylene, 1-butene, 1-pentene, 1-hexene, 1-heptene, 1-octene, and 1-decene; and branched olefins such as isobutene and 4-methyl-1-pentene. These olefin monomers may be used alone or in combination of two or more thereof. Among them, ethylene and propylene are preferable, and propylene is more preferable, from the viewpoint of improving alkali resistance.

The mass ratio of the monomer having a carboxy group to the olefin monomer [(monomer having a carboxy group)/(olefin monomer)] is preferably 0.1/99.9 to 50/50, more preferably 1/99 to 20/80, and still more preferably 1.5/98.5 to 15/85, from the viewpoint of making the binding property with the solid electrolyte exhibiting alkalinity more excellent. The method for producing the block copolymer is not particularly limited, and the block copolymer can be produced by a known polymerization method, for example, an ionic polymerization method such as anionic polymerization or cationic polymerization, or a radical polymerization method.

(Acid-Modified Resin Graft-Modified with Compound Having Carboxy Group)

In the acid-modified resin graft-modified with a compound having a carboxy group (hereinafter, also simply referred to as “acid-modified resin”), it is preferable that the main chain of the acid-modified resin is formed of an olefin monomer. When the acid-modified resin is used together with a resin not containing a carboxy group described later, the affinity between the resin containing a carboxy group and the resin not containing a carboxy group is enhanced, and therefore, an ion permeable membrane having higher quality can be obtained.

Examples of the olefin monomer forming the main chain of the acid-modified resin include those exemplified as the olefin monomer in the section of (Block Copolymer Containing Monomer Having Carboxy Group). The olefin monomer is preferably ethylene or propylene, and more preferably propylene, from the viewpoint of improving alkali resistance. These may be used alone or in combination of two or more kinds thereof.

The resin constituting the main chain of the acid-modified resin is preferably polypropylene, and the polypropylene may be a specific polypropylene exemplified as a resin not containing a carboxy group described later.

Examples of the polypropylene include a propylene homopolymer and a propylene-olefin copolymer, and a propylene homopolymer is preferable.

The acid-modified resin is obtained by grafting a compound having a carboxy group to a resin constituting the main chain.

The compound having a carboxy group is preferably a compound selected from an unsaturated carboxylic acid and derivatives thereof from the viewpoint of making the binding property with the solid electrolyte exhibiting alkalinity more excellent.

Examples of the unsaturated carboxylic acid and the derivatives thereof include those exemplified as the unsaturated carboxylic acid and the derivatives thereof in the section of (Block Copolymer Containing Monomer Having Carboxy Group).

The compound having a carboxy group is preferably a compound selected from acrylic acid, methacrylic acid, maleic acid, and derivatives thereof, and more preferably acrylic acid or maleic anhydride, from the viewpoint of making the binding property with the solid electrolyte exhibiting alkalinity more excellent. These may be used alone or in combination of two or more kinds thereof.

The acid modification amount of the acid-modified resin is preferably 0.5 to 20.0% by mass, more preferably 0.8 to 18.0% by mass, and still more preferably 1.0 to 15.0% by mass, from the viewpoint of further enhancing the binding property with the solid electrolyte exhibiting alkalinity.

The acid modification amount can be determined by infrared absorption (IR) spectrum measurement, and specifically, can be measured by the method described in Examples.

The method for producing the acid-modified resin is not particularly limited, and examples thereof include a radical graft reaction, that is, a reaction in which a radical species is generated with respect to the resin constituting the main chain, and a compound having a carboxy group is graft-polymerized using the radical species as a polymerization initiation point.

The radical generator is not particularly limited, and an organic peroxide is preferably used. Examples of the organic peroxide include peroxides such as di-tert-butyl peroxyphthalate, tert-butyl hydroperoxide, dicumyl peroxide, benzoyl peroxide, tert-butyl peroxybenzoate, tert-butyl peroxy-2-ethylhexanoate, tert-butyl peroxypivalate, methyl ethyl ketone peroxide, di-tert-butyl peroxide, and lauroyl peroxide; and azonitriles such as azobisisobutyronitrile and azobisisopropionitrile.

The resin containing a carboxy group has an acid value of more than 0 mgKOH/g, preferably 1 mgKOH/g or more and 100 mgKOH/g or less, and more preferably 5 mgKOH/g or more and 80 mgKOH/g or less, from the viewpoint of further enhancing the binding property with the solid electrolyte exhibiting alkalinity.

From the viewpoint of ease of mixing with the solid electrolyte, the weight-average molecular weight (Mw) of the resin containing a carboxy group is preferably 20,000 to 150,000, more preferably 25,000 to 100,000, and still more preferably 30,000 to 50,000. When the mixing is facilitated, the solid electrolyte and the resin are more uniformly present, so that the adhesion is enhanced, and as a result, it is possible to make it more difficult for water to permeate.

From the viewpoint of ease of mixing with the solid electrolyte, the molecular weight distribution (Mw/Mn) of the resin containing a carboxy group is preferably 1.5 to 4.0, more preferably 1.6 to 3.0, still more preferably 1.7 to 2.8, and yet still more preferably 1.8 to 2.5. When the mixing is facilitated, the solid electrolyte and the resin are more uniformly present, so that the adhesion is enhanced, and as a result, it is possible to make it more difficult for water to permeate.

In the description herein, the weight-average molecular weight (Mw) and the molecular weight distribution (Mw/Mn) are determined by gel permeation chromatography (GPC) measurement. The weight-average molecular weight is a polystyrene-equivalent weight-average molecular weight measured using the following apparatus under the following conditions, and the molecular weight distribution is a value calculated from the number-average molecular weight (Mn) measured in the same manner and the weight-average molecular weight (Mw).

### <GPC Measurement Apparatus>

Column: “TOSO GMHHR-H(S)HT” manufactured by Tosoh Corporation
Detector: RI detection for liquid chromatogram manufactured by Waters Corporation “WATERS 150C”

### <Measurement Conditions>

Solvent: 1,2,4-trichlorobenzene
Measurement temperature: 145° C.
Flow rate: 1.0 mL/min
Sample concentration: 5 mg/10 mL
Injection volume: 300 μL
Calibration curve: Universal Calibration
Analysis program: HT-GPC (Ver. 1.0)

The content of the resin containing a carboxy group contained in the ion permeable membrane is preferably 1% by mass or more and 30% by mass or less, more preferably 1% by mass or more and 25% by mass or less, and still more preferably 1% by mass or more and 20% by mass or less. When the content of the resin containing a carboxy group is 1% by mass or more, cracking and distortion at the time of production are less likely to occur, and the yield and the handleability become better, and when the content is 30% by mass or less, the recovery efficiency of ions can be further enhanced.

### (Resin Not Containing Carboxy Group)

The ion permeable membrane of the present embodiment preferably further contains a resin not containing a carboxy group. When the ion permeable membrane contains a resin not containing a carboxy group, the viscosity of the resin at the time of mixing is lowered, and the resin and the solid electrolyte are mixed well, whereby the adhesion is enhanced, and as a result, it is possible to make it more difficult for water to permeate.

The resin not containing a carboxy group may be present in the form of a mixture as a resin separate from the resin containing a carboxy group, or may be present in the form of a copolymer, but the former is preferable.

As the resin not containing a carboxy group, an olefin resin is preferable from the viewpoint of binding property with the resin containing a carboxy group and making it more difficult for water to permeate, and for example, polyethylene, polypropylene, or the like can be used. The olefin resin may be a homopolymer or a copolymer.

As the copolymer, a copolymer of ethylene or propylene and a monomer copolymerizable therewith can be used, and examples of the monomer copolymerizable with ethylene or propylene include α-olefins, styrenes, dienes, and cyclic compounds.

The α-olefins are preferably α-olefins having 4 to 30 carbon atoms, and specific examples thereof include linear olefins such as 1-butene, 1-pentene, 1-hexene, 1-heptene, 1-octene, and 1-decene, and branched olefins such as isobutene and 4-methyl-1-pentene. Examples of the styrenes include styrene, 4-methylstyrene, and 4-dimethylaminostyrene. Examples of the dienes include 1,3-butadiene, 1,5-hexadiene, 1,4-hexadiene, and 1,7-octadiene. Examples of the cyclic compounds include norbornene and cyclopentene. These copolymerizable monomers may be used alone or in combination of two or more kinds thereof. In addition, a copolymer of ethylene and propylene may be used.

The copolymer may be any of an alternating copolymer, a random copolymer, and a block copolymer.

As the resin not containing a carboxy group, polypropylene is preferable, and a propylene homopolymer is more preferable, from the viewpoint of further enhancing the binding property with the resin containing a carboxy group and from the viewpoint of making it more difficult for water to permeate.

From the viewpoint of further enhancing the flexibility, the polypropylene has a melting endotherm (ΔH-D) obtained from a melting endothermic curve obtained by holding a sample at −10° C. for 5 minutes under a nitrogen atmosphere and then raising the temperature at 10° C./min using a differential scanning calorimeter (DSC) of preferably 0 J/g or more and 80 J/g or less, more preferably 5 J/g or more and 70 J/g or less, still more preferably 10 J/g or more and 60 J/g or less, and yet still more preferably 15 J/g or more and 50 J/g or less. Due to the improvement in flexibility, cracking and distortion at the time of production are less likely to occur, and the yield and the handleability are improved.

The melting endotherm (ΔH-D) is calculated by obtaining an area surrounded by a line portion including a peak observed on the highest temperature side of a melting endothermic curve obtained by the DSC measurement and a baseline, using a line connecting a point on the low temperature side where there is no change in the amount of heat and a point on the high temperature side where there is no change in the amount of heat as the baseline.

The melting endotherm (ΔH-D) can be controlled by appropriately adjusting the monomer concentration and the reaction pressure.

From the viewpoint of further enhancing the flexibility, it is preferable that the melting point (Tm-D) of the polypropylene, which is defined as a peak top observed on the highest temperature side of a melting endothermic curve obtained by holding a sample at −10° C. for 5 minutes under a nitrogen atmosphere and then raising the temperature at 10° C./min using a differential scanning calorimeter (DSC), is not observed or is 0° C. or higher and 120° C. or lower. When a melting point is observed, the melting point is more preferably 20° C. or higher and 110° C. or lower, and still more preferably 30° C. or higher and 100° C. or lower. The melting point can be controlled by appropriately adjusting the monomer concentration and the reaction pressure. Due to the improvement in flexibility, cracking and distortion at the time of production are less likely to occur, and the yield and the handleability are improved.

The polypropylene has a softening point of preferably 90° C. or higher and 165° C. or lower, more preferably 100° C. or higher and 160° C. or lower, and still more preferably 115° C. or higher and 150° C. or lower, from the viewpoint of further enhancing the binding property with the resin containing a carboxy group.

The softening point can be measured by the Ring and Ball method in accordance with JAI7 1991.

The polypropylene has a weight-average molecular weight (Mw) of preferably 20,000 to 500,000, more preferably 25,000 to 300,000, and still more preferably 30,000 to 150,000, from the viewpoint of reducing the viscosity at the time of mixing.

The molecular weight distribution (Mw/Mn) of the resin containing a carboxy group is preferably 1.5 to 4.0, more preferably 1.6 to 3.0, still more preferably 1.7 to 2.8, and yet still more preferably 1.8 to 2.5, from the viewpoint of further enhancing the binding property with the resin containing a carboxy group.

As the polypropylene, a commercially available product can be used. Specific examples thereof include “S400”, “S410”, “S401”, “S600”, and “S901” of “L-MODU” (registered trademark) (manufactured by Idemitsu Kosan Co., Ltd.). Examples of commercially available products of the amorphous poly-α-olefin also include “REXtac” manufactured by REXtac, LLC, “Vestoplast” manufactured by Evonik Industries AG, and “Eastoflex” and “Aerafin” manufactured by Eastman (all of which are trade names). Examples of commercially available products of the propylene-based elastomer include “TAFMER XM”, “TAFMER PN”, and “TAFMER SN” manufactured by Mitsui Chemicals, Inc.; “Tafthren” manufactured by Sumitomo Chemical Co., Ltd.; “PRIME TPO” manufactured by Prime Polymer Co., Ltd.; “Versify” manufactured by The Dow Chemical Company; “Vistamaxx” and “Linxar” manufactured by Exxon Mobil Corporation; “Licocene” manufactured by Clariant Japan K. K.; and “Adflex” manufactured by LyondellBasell Industries (all are trade names).

The polypropylene can be obtained by polymerizing a monomer in the presence of a polymerization catalyst such as a Ziegler-Natta catalyst or a metallocene catalyst. Among them, the polypropylene is preferably a polypropylene obtained by a metallocene catalyst. The metallocene catalyst is a kind of homogeneous catalyst, and the resulting polymer is a uniform polymer having a narrow molecular weight distribution and a narrow composition distribution.

In a case where the ion permeable membrane of the present embodiment contains a resin not containing a carboxy group, the content of the resin not containing a carboxy group is preferably 3% by mass or more and 30% by mass or less, more preferably 5% by mass or more and 25% by mass or less, and still more preferably 6% by mass or more and 20% by mass or less. When the content of the resin not containing a carboxy group is 3% by mass or more, the binding property with the resin containing a carboxy group can be further enhanced, and when the content is 30% by mass or less, the lithium selectivity can be further enhanced. The mass ratio of the resin not containing a carboxy group to the resin containing a carboxy group [(resin not containing a carboxy group)/(resin containing a carboxy group)] is preferably 40/60 to 95/5, more preferably 45/55 to 95/5, and still more preferably 50/50 to 90/10, from the viewpoint of binding property.

### (Production of Ion Permeable Membrane)

The ion permeable membrane of the present embodiment is obtained, for example, by adding the solid electrolyte exhibiting alkalinity, the resin containing a carboxy group, and the resin not containing a carboxy group contained as necessary to a solvent, stirring and mixing the mixture to prepare a slurry, applying the obtained slurry onto a release film to form a coating film, and then drying the coating film.

Examples of the stirrer used for the stirring and mixing include a ball mill, a sand mill, a bead mill, an ultrasonic disperser, a homogenizer, a planetary mixer, and a FILMIX.

The solvent is not particularly limited, and examples thereof include hydrocarbon solvents such as aliphatic hydrocarbon solvents, alicyclic hydrocarbon solvents, and aromatic hydrocarbon solvents.

Examples of the aliphatic hydrocarbon include hexane, pentane, 2-ethylhexane, heptane, octane, decane, undecane, dodecane, and tridecane; examples of the alicyclic hydrocarbon include cyclohexane and methylcyclohexane; and examples of the aromatic hydrocarbon solvent include benzene, toluene, xylene, mesitylene, ethylbenzene, tert-butylbenzene, trifluoromethylbenzene, and nitrobenzene.

From the viewpoint of coatability of the slurry, the solid content concentration of the slurry is preferably 60.0 to 99.0% by mass, more preferably 65.0 to 95.0% by mass, and still more preferably 70.0 to 90.0% by mass, based on the total amount (100% by mass) of the slurry. In the description herein, the “solid content concentration” refers to the content (concentration) of components other than the solvent.

The method for applying the slurry onto the release film is not particularly limited, and examples thereof include a doctor blade method, a dip method, a reverse roll method, a direct roll method, a gravure method, an extrusion method, and brush coating.

In addition, the coating amount of the slurry is not particularly limited, and can be appropriately set according to the desired thickness of the ion permeable membrane and the like.

The method for drying the slurry on the release film is not particularly limited, and examples thereof include drying with warm air, hot air, or low-humidity air, vacuum drying, and drying by irradiation with (far) infrared rays, electron beams, or the like. The drying conditions can be appropriately set, and the drying temperature is preferably 50 to 200° C. and more preferably 60 to 150° C. The drying time is not particularly limited, and is usually in a range of 5 minutes or more and 20 hours or less, and preferably 5 minutes or more and 18 hours or less. The drying may be performed in one stage or in two stages.

The dried ion permeable membrane may be compacted by pressing. Examples of the pressing method include, but are not limited to, methods such as mold pressing, roll pressing, and calender pressing.

### [Ion Recovery Device]

The ion recovery device of the present embodiment is a device including an ion permeable membrane which includes a solid electrolyte exhibiting alkalinity and a resin containing a carboxy group, and has an acid value of more than 0 mgKOH/g. That is, the ion recovery device of the present embodiment is a device including the ion permeable membrane of the present embodiment described above. The ion permeable membrane of the present embodiment included in the recovery device of the present embodiment is as described above.

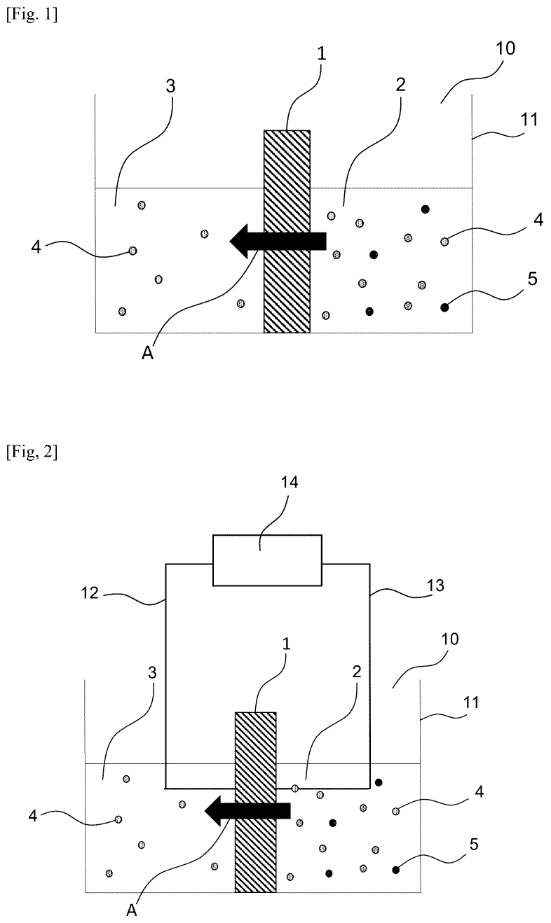

An example of a preferred configuration of an ion recovery device using the ion permeable membrane of the present embodiment is shown in FIG. 1 as a schematic diagram. For example, an ion recovery device 10 can move lithium ions from a treatment liquid containing lithium ions extracted from a treatment member or the like of a lithium secondary battery to a recovery liquid which is an aqueous solution and recover the lithium ions in the recovery liquid. The ion recovery device 10 is a device that recovers a target metal ion, a derivative of the metal ion, or a metal from a metal ion 4 to be recovered and an ion 5 other than the ion to be recovered contained in a treatment liquid 2.

The ion recovery device 10 includes, in a treatment tank 11, an ion permeable membrane 1 that selectively permeates a metal ion to be recovered. The ion permeable membrane 1 is installed in the treatment tank 11 so as to partition the treatment liquid and the recovery liquid with the treatment liquid on one main surface side and the recovery liquid on the other main surface side.

The ion recovery device 10 preferably has electrodes, and by having the electrodes, the metal ion to be recovered can efficiently and selectively permeate the ion permeable membrane 1 in a shorter time and move to the recovery liquid 3 (described as A), and the target ion can be recovered. The ion recovery device 10 may further include a storage tank that stores the recovery liquid, a recovery tank that recovers lithium ions from the recovery liquid, and a liquid feeding pipe that connects the storage tank and the recovery tank, as necessary.

### [Method for Producing Lithium Hydroxide]

The method for producing lithium hydroxide of the present embodiment is a method for producing lithium hydroxide, including recovering lithium hydroxide from a lithium ion-containing liquid using an ion permeable membrane that includes a solid electrolyte exhibiting alkalinity and a resin containing a carboxy group and has an acid value of more than 0 mgKOH/g. That is, the method for producing lithium hydroxide of the present embodiment uses the ion permeable membrane of the present embodiment described above. The ion permeable membrane of the present embodiment used in the method for producing lithium hydroxide of the present embodiment is as described above.

In the method for producing lithium hydroxide of the present embodiment, the production of lithium hydroxide is not particularly limited as long as the ion permeable membrane of the present embodiment is used, and can be performed, for example, by recovering lithium ions from a lithium ion-containing liquid and obtaining lithium hydroxide from a recovery liquid from which the lithium ions have been recovered. Here, in a case where lithium ions are recovered from a lithium ion-containing liquid, the recovery can be performed using an electrochemical device including the ion permeable membrane of the present embodiment, and as such an electrochemical device, for example, the ion recovery device of the present embodiment described above can be adopted.

The method of obtaining lithium hydroxide from the recovery liquid obtained by recovering lithium ions from the lithium ion-containing liquid is not particularly limited, and examples thereof include evaporation and drying by heating. In addition, a method of separating lithium hydroxide from the recovery liquid is also exemplified. More specifically, for example, a method by crystallization such as cooling crystallization or evaporation crystallization is preferably used. According to the method by crystallization, lithium hydroxide can be obtained without requiring a dehydration step such as concentration by heating, so that the energy consumption required for the dehydration step and the like can be reduced, and high purity lithium hydroxide can be produced more efficiently.

### [Method for Producing Lithium-Containing Substance]

The method for producing a lithium-containing substance of the present embodiment is a method including: recovering lithium hydroxide from a lithium ion-containing liquid by using an ion permeable membrane that includes a solid electrolyte exhibiting alkalinity and a resin containing a carboxy group and has an acid value of more than 0 mgKOH/g; and using the lithium hydroxide to produce a lithium-containing substance selected from lithium sulfide, a sulfide solid electrolyte, and an electrode active substance. That is, the method for producing a lithium-containing substance of the present embodiment uses lithium hydroxide obtained by the method for producing lithium hydroxide of the present embodiment described above. The method for producing lithium hydroxide employed in the method for producing a lithium-Containing Substance of the Present Embodiment is as Described Above.

### (Lithium-Containing Substance: Lithium Sulfide)

The lithium-containing substance obtained by the method for producing a lithium-containing substance of the present embodiment is a substance containing lithium selected from lithium sulfide, a sulfide solid electrolyte, and an electrode active substance.

Lithium sulfide can be produced, for example, by reacting lithium hydroxide with hydrogen sulfide.

### (Lithium-Containing Substance: Sulfide Solid Electrolyte)

The sulfide solid electrolyte can be produced, for example, by using lithium hydroxide or lithium sulfide obtained using lithium hydroxide as a solid electrolyte raw material, and reacting a raw material-containing substance containing other solid electrolyte raw materials by mixing or the like.

The other solid electrolyte raw material that can be used in combination with lithium hydroxide or lithium sulfide obtained using lithium hydroxide is not particularly limited as long as a sulfide solid electrolyte can be produced, and for example, a substance containing at least one atom selected from a lithium atom, a phosphorus atom, and a sulfur atom is preferably exemplified, and a substance containing at least one atom selected from a lithium atom, a phosphorus atom, a sulfur atom, and a halogen atom is more preferably exemplified.

Typical preferred examples of such solid electrolyte raw materials include raw materials containing at least two kinds of atoms selected from the above-mentioned atoms, such as phosphorus sulfides such as diphosphorus trisulfide (P₂S₃) and diphosphorus pentasulfide (P₂S₅); and raw materials consisting of one kind of atom selected from the above-mentioned atoms, such as elemental phosphorus and elemental sulfur. Among these, lithium sulfide and phosphorus sulfides such as diphosphorus trisulfide (P₂S₃) and diphosphorus pentasulfide (P₂S₅) are preferred, and among the phosphorus sulfides, diphosphorus pentasulfide (P₂S₅) is preferred.

The raw material-containing substance may further contain a halogen atom, and examples of the raw material also include substances containing a halogen atom. Typical examples thereof include lithium halides such as lithium fluoride, lithium chloride, lithium bromide, and lithium iodide; and halogen simple substances such as fluorine (F₂), chlorine (Cl₂), bromine (Br₂), and iodine (I₂).

The above solid electrolyte raw materials may be blended and used at a blending ratio that matches the composition of the sulfide solid electrolyte having a desired crystal structure. Examples of the blending ratio of lithium sulfide and other solid electrolyte raw materials contained in the raw material-containing substance include the blending ratio described in WO 2020/105737 (see paragraphs to [0028]) and the like. In addition, as the solid electrolyte raw material, it is also possible to appropriately select and use substances exemplified in WO 2020/105737 (see paragraphs to [0022]) and the like.

The reaction of the raw material-containing substance can be carried out by, for example, the production method (i) mixing, or the production method (ii) heat treatment in a pressure-resistant container or heat treatment in a solvent while refluxing. First, the production method (i) will be described.

### (Regarding Production Method (i))

The method of mixing the solid electrolyte raw materials containing lithium sulfide is not particularly limited as long as, for example, the above-described solid electrolyte raw materials can be mixed. For example, a pulverizer, a mixer, a stirrer, or the like may be used.

When a pulverizer is used, pulverization of the raw materials occurs, but mixing also occurs at the same time. Mixing of the raw materials can also take place using a mixer and a stirrer. Therefore, it can be said that the sulfide solid electrolyte obtained by the method for producing a lithium-containing substance of the present embodiment can be preferably produced by stirring, mixing, pulverizing, or a treatment combining any of these of two or more raw materials selected from substances containing at least one atom of a lithium atom, a sulfur atom, a phosphorus atom, and a halogen atom.

Equipment such as a pulverizer, a mixer, and a stirrer used for mixing the raw material-containing substances is not particularly limited, and equipment that is generally distributed can be used.

In the mixing, a solvent can be added to and mixed with the raw materials. As the solvent, various solvents widely referred to as organic solvents can be used. As the solvent, solvents that have been conventionally used in the production of solid electrolytes can be widely adopted, and examples thereof include hydrocarbon solvents such as aliphatic hydrocarbon solvents, alicyclic hydrocarbon solvents, and aromatic hydrocarbon solvents.

Examples of the solvent include, in addition to the above-described hydrocarbon solvents, a solvent containing a hetero atom such as an atom other than a carbon atom and a hydrogen atom, for example, a nitrogen atom, an oxygen atom, a sulfur atom, and a halogen atom. Such a solvent has a property of easily forming a complex with a raw material or the like containing a lithium atom, a phosphorus atom, a sulfur atom, an oxygen atom, and a halogen atom used as a raw material (hereinafter, such a solvent is also referred to as a “complexing agent”) (since a sulfide solid electrolyte is obtained by removing the complexing agent from the “complex”, the solvent can also be referred to as an “electrolyte precursor”), and has a property of easily keeping the halogen atom in the structure of the sulfide solid electrolyte, and thus is useful in that a higher ionic conductivity is obtained. In addition, in a case where the complexing agent is used, in the mixing of the solid electrolyte raw materials, the reaction of the solid electrolyte raw materials can be allowed to proceed only by using a device such as a mixer or a stirrer, that is, without using a pulverizer, which is useful.

Examples of the complexing agent and the hydrocarbon solvent that can be used include complexing agents and hydrocarbon solvents disclosed in WO 2020/105737 and the like.

As the complexing agent, among the solvents containing a hetero atom, a solvent containing a nitrogen atom is preferred, an amine solvent having an amino group is more preferred, and a diamine solvent having two amino groups is further preferred.

### (Drying)

When the sulfide solid electrolyte is produced and the mixing is performed using a solvent, the method may include drying a fluid (usually, slurry) obtained by the mixing after the mixing is performed. The sulfide solid electrolyte is obtained by removing the complexing agent from the complex containing the complexing agent when the complexing agent is used as the solvent, by removing the complexing agent from the complex containing the complexing agent and removing the solvent when the complexing agent and the solvent are used in combination, or by removing the solvent when the solvent other than the complexing agent is used.

The drying method is not particularly limited as long as the solvent can be removed, and the drying may be performed by solid-liquid separation, drying by heating, reduced pressure drying (vacuum drying), or a combination thereof.

In a case where the complexing agent is used as the solvent and the complexing agent is removed from the complex (electrolyte precursor), as a method of drying, drying by heating is preferable, and drying is preferably performed by a dryer such as a flow type heater. This is because the complexing agent can be quickly removed from the complex (electrolyte precursor), and thus the generation of impurities can be more efficiently suppressed, so that a high-quality sulfide solid electrolyte can be obtained. Preferred examples of the flow type heater include a flash dryer, a spray dryer, and a fluidized dryer using a medium, and among these, a flash dryer is preferred.

### (Heating)

When the sulfide solid electrolyte is produced, heating may be further included. In a case where an amorphous sulfide solid electrolyte (glass component) is obtained by the mixing, a crystalline sulfide solid electrolyte is obtained by heating, and in a case where a crystalline sulfide solid electrolyte is obtained by the mixing, a crystalline sulfide solid electrolyte having a further improved crystallinity is obtained by heating. In any case, by heating, the obtained sulfide solid electrolyte can be made into a crystalline sulfide solid electrolyte, and the ionic conductivity can be improved. That is, it can be said that the heating is an operation performed for crystallization.

In a case where a complexing agent is used as a solvent at the time of mixing, a complex containing the complexing agent is formed, but the complexing agent is removed from the complex even by heating without performing the above-described drying to obtain a sulfide solid electrolyte, and the sulfide solid electrolyte can be amorphous or crystalline depending on the heating conditions.

(Regarding Production Method (ii))

The production method (ii) is a production method in which the reaction of the raw material-containing substance is carried out by heat treatment in a pressure-resistant container or heat treatment in a solvent while refluxing. In a case where the method for producing a sulfide solid electrolyte of the present embodiment employs performing a heat treatment in a pressure-resistant container, the method is suitable for producing a sulfide solid electrolyte having an argyrodite type crystal structure described later. The details of the heat treatment in a pressure-resistant container or the heat treatment in a solvent while refluxing in the production method (ii) are described in JP 2020-095953 and the like, and thus the details may be followed.

According to the production methods (i) and (ii), an amorphous sulfide solid electrolyte and a crystalline sulfide solid electrolyte are obtained as the sulfide solid electrolyte.

The amorphous sulfide solid electrolyte preferably contains a lithium atom, a sulfur atom, and a phosphorus atom, and preferably further contains a halogen atom. Typical examples thereof include solid electrolytes composed of lithium sulfide, phosphorus sulfide, and a lithium halide, such as Li₂S—P₂S₅, Li₂S—P₂S₅—LiI, Li₂S—P₂S₅—LiCl, Li₂S—P₂S₅—LiBr, and Li₂S—P₂S₅—LiI—LiBr; and solid electrolytes containing other atoms such as an oxygen atom and a silicon atom, such as Li₂S—P₂S₅—Li₂O—LiI and Li₂S—SiS₂—P₂S₅—LiI. From the viewpoint of obtaining higher ionic conductivity, solid electrolytes composed of lithium sulfide, phosphorus sulfide, and a lithium halide, such as Li₂S—P₂S₅—LiI, Li₂S—P₂S₅—LiCl, Li₂S—P₂S₅—LiBr, and Li₂S—P₂S₅—LiI—LiBr, are preferred.

The types of atoms constituting the amorphous sulfide solid electrolyte can be determined by, for example, an ICP emission spectrophotometer.

In the amorphous sulfide solid electrolyte, the blending ratio (molar ratio) of lithium atoms, sulfur atoms, phosphorus atoms, and halogen atoms is preferably 1.0 to 1.8:1.0 to 2.0:0.1 to 0.8:0.01 to 0.6, more preferably 1.1 to 1.7:1.2 to 1.8:0.2 to 0.6:0.05 to 0.5, and still more preferably 1.2 to 1.6:1.3 to 1.7:0.25 to 0.5:0.08 to 0.4. Further, when bromine and iodine are used together as halogen atoms, the blending ratio (molar ratio) of lithium atoms, sulfur atoms, phosphorus atoms, bromine, and iodine is preferably 1.0 to 1.8:1.0 to 2. 0:0.1 to 0.8:0.01 to 0.3:0.01 to 0.3, more preferably 1.1 to 1.7:1.2 to 1.8:0.2 to 0. 6:0.02 to 0.25:0.02 to 0.25, still more preferably 1.2 to 1.6:1.3 to 1.7:0.25 to 0.5:0.03 to 0.2:0.03 to 0.2, and yet still more preferably 1.35 to 1.45:1.4 to 1.7:0.3 to 0.45:0.04 to 0.18:0.04 to 0.18. By setting the blending ratio (molar ratio) of lithium atoms, sulfur atoms, phosphorus atoms, and halogen atoms within the above range, it becomes easy to obtain a solid electrolyte having a thio-LISICON Region II type crystal structure, an argyrodite type crystal structure, or the like to be described later and having a higher ionic conductivity.

The crystalline sulfide solid electrolyte may be a so-called glass ceramic obtained by heating an amorphous sulfide solid electrolyte to a crystallization temperature or higher, and examples of a crystal structure thereof include a Li₃PS₄ crystal structure, a Li₄P₂S₆ crystal structure, a Li₇PS₆ crystal structure, a Li₇P₃S₁₁ crystal structure, and a crystal structure having peaks in the vicinity of 20=20.2° and in the vicinity of 23.6° (for example, JP 2013-16423 A).

Preferred examples of the crystal structure include a thio-LISICON Region II type crystal structure and an argyrodite type crystal structure. Details of these crystal structures are described in, for example, WO 2024/010078 and WO 2024/010079.

The composition ratio of the atoms contained in the crystalline sulfide solid electrolyte is a composition ratio according to a compositional formula corresponding to each of the above-described various crystal structures, and is preferably within the range of the composition ratio of each atom contained in the above-described amorphous sulfide solid electrolyte. When the composition ratio of each atom is within the range of the composition ratio of each atom, a thio-LISICON Region II type crystal structure or an argyrodite type crystal structure is easily formed among the above-described crystal structures.

The sulfide solid electrolyte thus obtained can be used as it is for a solid electrolyte layer (separator layer) of a lithium ion battery, or can be mixed with an electrode active substance described later and used as an electrode mixture for a positive electrode or a negative electrode.

### (Lithium-Containing Substance: Electrode Active Substance)

The electrode active substance can be produced, for example, by using lithium hydroxide or lithium sulfide obtained using lithium hydroxide as a raw material, mixing the raw material with other raw materials such as hydroxide salts, halide salts, carbonates, and oxides containing atoms such as cobalt, nickel, manganese, iron, and phosphorus by wet mixing or dry mixing, and then firing the mixture.

Preferred examples of the electrode active substance thus obtained include lithium-containing transition metal composite oxides such as LMO (lithium manganate), LCO (lithium cobaltate), NMC (lithium nickel manganese cobaltate), NCA (lithium nickel cobalt aluminate), LNCO (lithium nickel cobaltate), olivine type compounds (LiMeNPO₄, Me=Fe, Co, Ni, Mn), LFP (lithium ferrous phosphate), and NM (lithium nickel manganate). These lithium-containing transition metal composite oxides are also referred to as oxide positive electrode active substances, and are mainly used as positive electrode active substances.

The electrode active substance obtained by the method for producing a lithium-containing substance of the present embodiment can be mixed with, for example, a sulfide solid electrolyte also obtained by the method for producing a lithium-containing substance of the present embodiment, and used as an electrode mixture.

The blending ratio (mass ratio) of the electrode active substance and the sulfide solid electrolyte in the electrode mixture is preferably 99.5:0.5 to 40:60, more preferably 99:1 to 50:50, and still more preferably 98:2 to 60:40, in order to improve battery performance and consider production efficiency.

In addition, in the case of an electrode mixture, as a component other than the electrode active substance and the sulfide solid electrolyte, it is possible to use a conductive material which is a carbon-based material such as artificial graphite, graphite carbon fiber, resin baked carbon, pyrolytic vapor-grown carbon, coke, mesocarbon microbeads, furfuryl alcohol resin baked carbon, polyacene, pitch-based carbon fiber, vapor-grown carbon fiber, natural graphite, and nongraphitizing carbon, and a binder of various resins such as fluorine-based polymers such as polytetrafluoroethylene and polyvinylidene fluoride, thermoplastic elastomers such as butylene rubber and styrene-butadiene rubber, acrylic resin, acrylic polyol resin, polyvinyl acetal resin, polyvinyl butyral resin, and silicone resin.

When containing a conductive material, the content of the conductive material in the electrode mixture is not particularly limited, however in order to improve battery performance and consider production efficiency, it is preferably 0.5% by mass or more, more preferably 1% by mass or more, and still more preferably 1.5% by mass or more, and the upper limit is preferably 10% by mass or less, more preferably 8% by mass or less, and still more preferably 5% by mass or less.

When containing a binder, the content of the binder in the electrode mixture is not particularly limited, however in order to improve battery performance and consider production efficiency, it is preferably 1% by mass or more, more preferably 3% by mass or more, and still more preferably 5% by mass or more, and the upper limit is preferably 20% by mass or less, more preferably 15% by mass or less, and still more preferably 10% by mass or less.

The electrode active substance can be used as an electrode mixture, and the electrode mixture can be used as a positive electrode layer or a negative electrode layer of a lithium ion battery.

### [Method for Producing Lithium Ion Battery]

The method for producing a lithium-ion battery of the present embodiment includes: recovering lithium hydroxide from a lithium ion-containing liquid by using an ion permeable membrane that includes a solid electrolyte exhibiting alkalinity and a resin containing a carboxy group and has an acid value of more than 0 mgKOH/g; obtaining a lithium-containing substance selected from lithium sulfide, a sulfide solid electrolyte, and an electrode active substance by using the lithium hydroxide; and using a substance selected from the lithium-containing substances. That is, the method for producing a lithium ion battery of the present embodiment uses the lithium-containing substance obtained by the method for producing a lithium-containing substance of the present embodiment described above. The method for producing a lithium-containing substance employed in the method for producing a lithium ion battery of the present embodiment is as described above.

The substance selected from lithium-containing substances used in the production method of the present embodiment is a substance selected from lithium sulfide, a sulfide solid electrolyte, and an electrode active substance, and a sulfide solid electrolyte and an electrode active substance are preferably used.

As described above, the sulfide solid electrolyte is preferably used as it is in a solid electrolyte layer of a lithium-ion battery, and is preferably used in a positive electrode or a negative electrode of a lithium ion battery as an electrode mixture by being mixed with an electrode active substance. In addition, the electrode active substance is mixed with a solid electrolyte such as a sulfide solid electrolyte to form an electrode mixture, which is preferably used for a positive electrode or a negative electrode of a lithium ion battery.

The lithium ion battery obtained by the production method of the present embodiment preferably includes, for example, a positive electrode layer, a negative electrode layer, an electrolyte layer, and a current collector. The above-described electrode mixture is preferably used as the positive electrode layer and the negative electrode layer, and the sulfide solid electrolyte obtained by the method for producing a lithium-containing substance of the present embodiment is preferably used as the electrolyte layer.

As the current collector, a known current collector may be used. For example, a layer in which a material that reacts with the solid electrolyte, such as Au, Pt, Al, Ti, or Cu, is covered with Au or the like can be used.

### EXAMPLES

Hereinafter, the present invention will be specifically described with reference to Examples, but the present invention is not limited to these Examples.

Details of the raw material compounds used in Synthesis Examples and Examples are as follows.
Polypropylene (1): L-MODU (registered trademark) S400, manufactured by Idemitsu Kosan Co., Ltd., melting endotherm (ΔH-D)=36 J/g, melting point (Tm-D)=80° C., weight-average molecular weight (Mw)=45,000, molecular weight distribution (Mw/Mn)=2.0, polypropylene obtained by a metallocene catalyst
Polypropylene (2): L-MODU (registered trademark) S901, manufactured by Idemitsu Kosan Co., Ltd., melting endotherm (ΔH-D)=40 J/g, melting point (Tm-D)=80° C., weight-average molecular weight (Mw)=130,000, molecular weight distribution (Mw/Mn)=2.0, polypropylene obtained by a metallocene catalyst
LLTO (1): a mixed product of “TP-02N (calcined at 1300° C. in air), manufactured by TOHO TITANIUM CO., LTD., average particle diameter: 20 μm” and “TP-02F, manufactured by TOHO TITANIUM CO., LTD., average particle diameter: 1 μm” at a mass ratio of TP-02N:TP-02F=80:20

The melting endotherm (ΔH-D), melting point (Tm-D), weight-average molecular weight (Mw), and molecular weight distribution of the polypropylenes (1) and (2) were measured by the following methods.

### [DSC Measurement]

The melting endotherm (ΔH-D) was determined from a melting endothermic curve obtained by holding 10 mg of a sample at −10° C. for 5 minutes under a nitrogen atmosphere and then raising the temperature at 10° C./min, using a differential scanning calorimeter (manufactured by PerkinElmer Co., Ltd., “DSC-7”). In addition, the melting point (Tm-D) was determined from the peak top of the peak observed on the highest temperature side of the obtained melting endothermic curve.

The melting endotherm (ΔH-D) is calculated by obtaining an area surrounded by a line portion including a peak of a melting endothermic curve obtained by DSC measurement using a differential scanning calorimeter (“DSC-7” manufactured by PerkinElmer Co., Ltd.) and a baseline, the baseline being a line connecting a point on the low temperature side where there is no change in the amount of heat and a point on the high temperature side where there is no change in the amount of heat.

### [Measurement of Weight-Average Molecular Weight (Mw) and Molecular Weight Distribution (Mw/Mn)]

The weight-average molecular weight (Mw) and the number-average molecular weight (Mn) were measured by a gel permeation chromatography (GPC) method, and the molecular weight distribution (Mw/Mn) was determined. The following apparatus and conditions were used for the measurement, and the weight-average molecular weight and the number-average molecular weight in terms of polystyrene were obtained. The molecular weight distribution (Mw/Mn) is a value calculated from the weight-average molecular weight (Mw) and the number-average molecular weight (Mn).

### <GPC Measurement Apparatus>

Column: “TOSO GMHHR-H(S)HT” manufactured by Tosoh Corporation
Detector: RI detection for liquid chromatogram “WATERS 150C” manufactured by Waters Corporation

### <Measurement Conditions>

Solvent: 1,2,4-trichlorobenzene
Measurement temperature: 145° C.
Flow rate: 1.0 mL/min
Sample concentration: 5 mg/10 mL
Injection volume: 300 μL
Calibration curve: Universal Calibration
Analysis program: HT-GPC (Ver. 1.0)

### (Acid-Modified Polypropylene)

Acid-modified polypropylenes (1) to (3) synthesized by changing the mixing ratio of polypropylene (1) and maleic anhydride were prepared. The acid-modified polypropylene (1) has an acid value of 15.3 mgKOH/g and an acid modification amount of 1.8% by mass, the acid-modified polypropylene (2) has an acid value of 42.7 mgKOH/g and an acid modification amount of 6.3% by mass, and the acid-modified polypropylene (3) has an acid value of 71.2 mgKOH/g and an acid modification amount of 10.9% by mass. Respective acid values and acid modification amounts were measured by the following methods.

### [Acid Value]

The acid values of the acid-modified polypropylenes (1) to (3) were measured in accordance with JIS K0070:1992. The acid value of the ion permeable membrane obtained in Examples was calculated from the acid value and the content of the acid-modified polypropylene contained in the ion permeable membrane.

### [Acid Modification Amount]

A mixture of polypropylene and maleic anhydride before modification was pressed using a 0.1 mm spacer, then the IR was measured, a calibration curve was prepared from the absorption amount of characteristic carbonyl (1600 to 1900 cm⁻¹) and the charge amount of maleic anhydride, and the IR measurement of the pressed plate of the acid-modified polypropylene was performed to measure the acid modification amount.
IR measurement device: “Nicolet 8700” manufactured by Thermo Fisher Scientific

### Example 1

To a rotation and revolution type mixing mixer (Awatori Rentaro (registered trademark) AR310, manufactured by Thinky Corporation), 80 parts by mass of “TP-02N, manufactured by TOHO TITANIUM CO., LTD., average particle diameter: 20 μm” and 20 parts by mass of “TP-02F, manufactured by TOHO TITANIUM CO., LTD., average particle diameter: 1 μm” as solid electrolytes exhibiting alkalinity were added, stirred and mixed at a rotation speed of 2000 rpm for 1 minute, allowed to cool at room temperature (25° C.) for 1 minute, and then further stirred and mixed at a rotation speed of 2000 rpm for 1 minute to obtain LLTO (1) (a mixed product of TP-02N and TP-02F).

Next, 50 parts by mass of polypropylene (2) as a resin not containing a carboxy group and 50 parts by mass of acid-modified polypropylene (1) as a resin containing a carboxy group were added to a rotation and revolution type mixing mixer (Awatori Rentaro (registered trademark) AR310, manufactured by Thinky Corporation) to which 40 parts by mass of xylene was added as a solvent, stirred and mixed at a rotation speed of 2000 rpm for 10 minutes, then the above LLTO (1) was added such that the mass ratio with respect to the resin in the slurry was LLTO (1):resin=80:20, the operation in which the mixture was stirred and mixed at a rotation speed of 2000 rpm for 5 minutes, and ice-cooled for 5 minutes was repeated twice to prepare a slurry having a solid content concentration of 75% by mass.

The slurry was vacuum-defoamed at 45° C. for 3 minutes, and then a half amount of the slurry was applied onto a PTFE film using a desktop coating machine so as to have a film thickness of 500 μm to form a coating film. After the coating film was dried at 50° C. for 20 minutes using a hot plate, the remaining slurry was applied to the coating film so that the film thickness was 500 μm, dried at 50° C. for 20 minutes, and further dried in vacuum at 120° C. for 6 hours to obtain an ion permeable membrane.

A water leakage test (solution isolation test) and a Li selectivity test, which will be described later, were performed on the prepared ion permeable membrane. The results are shown in Table 1 and Table 2.

### Examples 2 to 5 and Comparative Examples 1 and 2

An ion permeable membrane was obtained in the same manner as in Example 1 except that each component and the blending amount were changed as shown in Table 1.

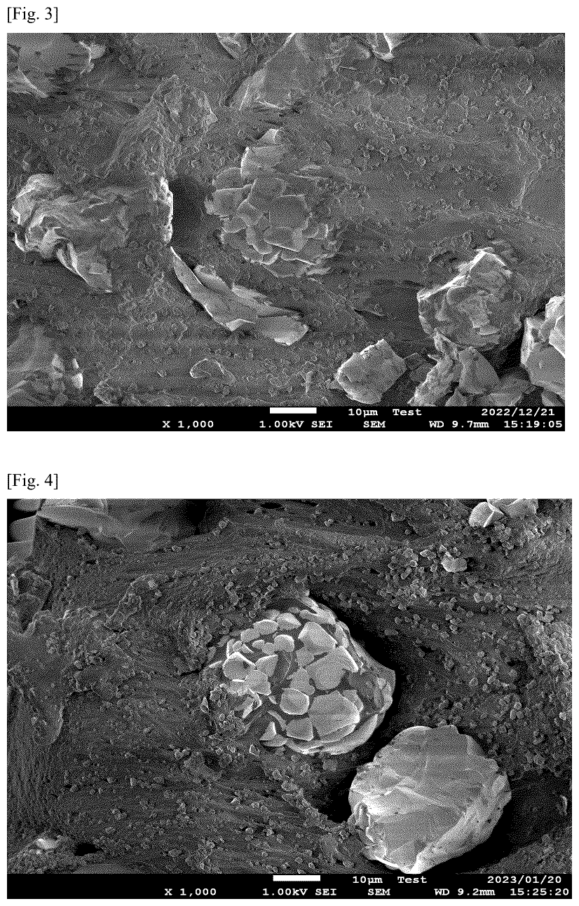

The produced ion permeable membrane was subjected to a water leakage test (solution isolation test) described later. The results are shown in Table 1. In addition, an SEM image (magnification: 1000 times) of a cross section of the ion permeable membrane produced in Example 4 is shown in FIG. 3, and an SEM image (magnification: 1000 times) of a cross section of the ion permeable membrane produced in Comparative Example 2 is shown in FIG. 4.

### [Water Leakage Test (Solution Isolation Test)]

The ion permeable membrane cut into a size of 25 mm×25 mm was set in an acrylic ion recovery device shown in FIGS. 1, and 15 mL of a 1.0 mol/L potassium hydroxide aqueous solution as a treatment liquid and 15 mL of an ion-exchanged water as a recovery liquid were set on one side and the other side, respectively. After being left at room temperature (25° C.) for 24 hours, 0.5 mL of the recovery liquid was collected after 0 hour, 2 hours, and 4 hours, and the potassium ion concentration was measured by ion chromatography (IC-8100, manufactured by Tosoh Corporation).

### [Li Selectivity Test]

The ion permeable membrane cut into a size of 25 mm×25 mm was set in an acrylic electrodeposition apparatus shown in FIG. 2, 50 mL of a 1.0 mol/L potassium hydroxide aqueous solution as a treatment liquid was set in a tank on the electrode (IrO₂) side, 100 mL of ion-exchanged water as a recovery liquid was set in a tank on the electrode (Sns) side, and a voltage of 5 V was applied for 24 hours. After 1 hour, 50 mL of a 1.0 mol/L lithium hydroxide aqueous solution was added as a treatment liquid to the tank on the electrode (IrO₂) side. After 0 minute, 30 minutes, and 60 minutes, the recovery liquid was collected at 0.5 mL, and the potassium ion concentration and the lithium ion concentration were measured by ion chromatography (IC-8100, manufactured by Tosoh Corporation).

TABLE 1

| | | Example 1 | Example 2 | Example 3 | Example 4 |
|---|---|---|---|---|---|
| Resin containing carboxy | Acid-modified | 50 | — | — | 50 |
| group (parts by mass) | polypropylene (1) | | | | |
| | Acid-modified | — | 10 | — | — |
| | polypropylene (2) | | | | |
| | Acid-modified | — | — | 10 | — |
| | polypropylene (3) | | | | |
| Resin not containing carboxy | Polypropylene (2) | 50 | 90 | 90 | 50 |
| group (parts by mass) | | | | | |

| | | | | |
|---|---|---|---|---|
| Resin (parts by mass) | 100 | 100 | 100 | 100 |

Slurry

| Solid electrolyte exhibiting | | LLTO(1) | 80 | 80 | 80 | 85 |
|---|---|---|---|---|---|---|
| alkalinity (parts by mass) | | | | | | |
| Resin (parts by mass) | | | 20 | 20 | 20 | 15 |
| Solvent (parts by mass) | | Xylene | 40 | 40 | 40 | 40 |
| Acid value | | | 7.65 | 4.27 | 7.12 | 7.65 |
| Water | K | After 0 hour | 0.0 | 0.0 | 0.0 | 0.0 |
| leakage test | concentration | After 2 hours | 0.0 | 0.0 | 0.0 | 0.0 |
| | (mg/L) | After 4 hours | 0.0 | 0.0 | 0.0 | 0.0 |

| | | | Comparative | Comparative |
|---|---|---|---|---|
| | | Example 5 | Example 1 | Example 2 |
| Resin containing carboxy | Acid-modified | — | — | — |
| group (parts by mass) | polypropylene (1) | | | |
| | Acid-modified | 30 | — | — |
| | polypropylene (2) | | | |
| | Acid-modified | — | — | — |
| | polypropylene (3) | | | |
| Resin not containing carboxy | Polypropylene (2) | 70 | 100 | 100 |
| group (parts by mass) | | | | |

| | | | |
|---|---|---|---|
| Resin (parts by mass) | 100 | 100 | 100 |

Slurry

| Solid electrolyte exhibiting | | LLTO(1) | 85 | 80 | 85 |
|---|---|---|---|---|---|
| alkalinity (parts by mass) | | | | | |
| Resin (parts by mass) | | | 15 | 20 | 15 |
| Solvent (parts by mass) | | Xylene | 40 | 40 | 40 |
| Acid value | | | 12.81 | 0.00 | 0.00 |
| Water | K | After 0 hour | 0.0 | 0.0 | 0.0 |
| leakage test | concentration | After 2 hours | 0.0 | 4.7 | 0.1 |
| | (mg/L) | After 4 hours | 0.0 | 71.6 | 4.9 |

TABLE 2

| | | | Example 1 |
|---|---|---|---|
| Li selectivity | K concentration | After 0 minute | 0.0 |
| test | (mg/L) | After 30 minutes | 0.0 |
| | | After 60 minutes | 0.0 |
| | Li concentration | After 0 minute | 0.2 |
| | (mg/L) | After 30 minutes | 0.2 |
| | | After 60 minutes | 0.3 |

As shown in Table 1, it can be seen that the ion permeable membranes of Examples 1 to 5 are all impermeable to water and have high qualities as a permeable membrane. Further, as shown in Table 2, it was confirmed that the ion permeable membrane of Example 1 has lithium selectivity.

In addition, in the ion permeable membrane of Example 4 shown in FIG. 3, it is found that both the solid electrolyte having an average particle diameter of 20 μm and the solid electrolyte having an average particle diameter of 1 μm are in close contact with the resin. On the other hand, in the ion permeable membrane of Comparative Example 2 shown in FIG. 4, many gaps were observed around the solid electrolyte having an average particle diameter of 20 μm, and floating of the solid electrolyte having an average particle diameter of 1 μm was observed between the solid electrolyte and the resin. Therefore, it is considered that the adhesiveness between the solid electrolyte and the resin was low, and as a result, water permeation occurred in the ion permeable membrane.

### REFERENCE SIGNS LIST

1: Ion permeable membrane
2: Treatment liquid
3: Recovery liquid
4: Metal ion to be recovered
5: Ion other than ion to be recovered
10: Ion recovery device
11: Treatment tank
12: Electrode (IrO₂)
13: Electrode (Sns)
14: Power supply device
A: Movement of ions to be recovered

1. An ion permeable membrane comprising a solid electrolyte exhibiting alkalinity and a resin containing a carboxy group, wherein the ion permeable membrane has an acid value of more than 0 mgKOH/g.

2. The ion permeable membrane according to claim 1, wherein the solid electrolyte exhibiting alkalinity is an oxide solid electrolyte.

3. The ion permeable membrane according to claim 1, wherein the resin containing a carboxy group is selected from a block copolymer containing a monomer having a carboxy group and an acid-modified resin graft-modified with a compound having a carboxy group.

4. The ion permeable membrane according to claim 3, wherein the block copolymer is a block copolymer of a monomer having a carboxy group and an olefin monomer.

5. The ion permeable membrane according to claim 3, wherein the main chain of the acid-modified resin is formed from an olefin monomer.

6. The ion permeable membrane according to claim 3, wherein the monomer having a carboxy group is a compound selected from unsaturated carboxylic acids and derivatives thereof.

7. The ion permeable membrane according to claim 3, wherein the compound having a carboxy group is a compound selected from unsaturated carboxylic acids and derivatives thereof.

8. The ion permeable membrane according to claim 6, wherein the monomer having a carboxy group and the compound having a carboxy group are each a compound selected from acrylic acid, methacrylic acid, maleic acid, and derivatives thereof.

9. The ion permeable membrane according to claim 1, further comprising a resin not containing a carboxy group.

10. The ion permeable membrane according to claim 9, wherein the resin not containing a carboxy group is an olefin resin.

11. The ion permeable membrane according to claim 1, wherein a content of the resin containing a carboxy group is 1% by mass or more and 30% by mass or less.

12. The ion permeable membrane according to claim 1, wherein the acid value is more than 0 mg KOH/g and 20 mg KOH/g or less.

13. The ion permeable membrane according to claim 1, which allows lithium ions to permeate.

14. The ion permeable membrane according to claim 1, which is used for recovering lithium ions.

15. A lithium recovery device comprising an ion permeable membrane that includes a solid electrolyte exhibiting alkalinity and a resin containing a carboxy group and has an acid value of more than 0 mgKOH/g.

16. A method for producing lithium hydroxide, comprising recovering lithium hydroxide from a lithium ion-containing liquid using an ion permeable membrane that includes a solid electrolyte exhibiting alkalinity and a resin containing a carboxy group and has an acid value of more than 0 mgKOH/g, or
a method for producing a lithium-containing substance, comprising: recovering lithium hydroxide from a lithium ion-containing liquid by using an ion permeable membrane that includes a solid electrolyte exhibiting alkalinity and a resin containing a carboxy group and has an acid value of more than 0 mgKOH/g; and using the lithium hydroxide to produce a lithium-containing substance selected from lithium sulfide, a sulfide solid electrolyte, and an electrode active substance, or
a method for producing a lithium ion battery, comprising: recovering lithium hydroxide from a lithium ion-containing liquid by using an ion permeable membrane that includes a solid electrolyte exhibiting alkalinity and a resin containing a carboxy group and has an acid value of more than 0 mgKOH/g; obtaining a lithium-containing substance selected from lithium sulfide, a sulfide solid electrolyte, and an electrode active substance by using the lithium hydroxide; and using a substance selected from the lithium-containing substances.

17. (canceled)

18. (canceled)
